(19) United States
(12) Patent Application Publication
(10) Pub. No.: US 2010/0138264 A1
(43) Pub. Date: Jun. 3, 2010

(54) DYNAMIC BUSINESS ENHANCEMENT SYSTEM

(75) Inventors: Andrew Bruce Faris, Auckland (NZ); Richard Li, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: TOTAL COMMUNICATIONS LIMITED, Auckland (NZ)

(21) Appl. No.: 11/570,293

(22) PCT Filed: Jun. 9, 2005
(86) PCT No.: PCT/NZ2005/000121

§ 371 Date: Mar. 25, 2008

(30) Foreign Application Priority Data
Jun. 9, 2004 (NZ) 533494

(51) Int. Cl. G06Q 10/00; G06Q 30/00; G06F 17/30

(52) U.S. Cl. 705/8; 705/10; 707/769; 707/E17.108

(57) ABSTRACT

A computer enabled business system is disclosed which provides a business with the ability to be aware on a moment-to-moment basis of their historic, current and future operational states. The business system uses a dynamic data engine for the purposes of creating and displaying historic transactions, current stock levels and forecasted demand data in real-time. As the data is created and cast forward, the data retains attributes of the original transaction data. These attributes are configured and modified dynamically resulting in precise and managed demand forecast, budget and purchasing information. Any change in the raw data as a result of a business transaction is immediately reflected in the demand forecast; hence, the data is in a perpetual dynamic state.

### BACKGROUND TO THE INVENTION

1. Field of the Invention

The present invention relates to a business system which provides precise and managed forecast, budget and purchasing information. More specifically, the present invention relates to a business system for dynamically updating historic and current transaction information and predicting, in real-time, future demand forecasting information that can be used and applied across each area of a business.

2. Summary of the Prior Art

There are a number of well known computer-integrated business systems which model the processes and systems required to run a business with the aim of reducing operating costs. In most systems the protocols are designed to model the paper-based processes in order to increase efficiency in executing these processes whilst reducing the associated costs. These systems are typically referred to as Enterprise Resource Planning (ERP) systems, the more popular systems being SAP, Baan, J. D. Edwards, Oracle and PeopleSoft. At the core of these systems are relational databases which provide a means of storing and retrieving business information across a computer network. The computer-integrated business systems provide simple transactional data in real-time thereby providing up-to-date transactional information which can be shared across a business supply chain for forecasting, planning and execution.

It has been found however, that these systems perform below businesses expectations requiring data to be manipulated and/or added to by a user before it is in the desired form and accessible for planning purposes. Conventional ERP systems are often not well suited to small and medium size businesses. Firstly, the cost of implementation is exorbitant and secondly, scaled-down ERP systems do not provide the degree of flexibility often inherent in small to medium size business operations.

WO 02071244A to Accelerate Software Inc. discloses a system and method for retrieving and integrating data from a number of databases in a computer network. A user issues a request for data or information via a computer network, such as the Internet, to an aggregation server. The aggregation server processes the request and determines which agent or agents has access to the data requested and communicates the request to the relevant agent(s). Each agent is designed to communicate with a specific group of data sources to retrieve and integrate the requested data. The data sources include databases and applications capable of supplying data which may not necessarily reside on one computer system. The retrieved data is then transferred between the agent and aggregation server which integrates all the data for presentation to the user. Whilst this system and method is capable of querying, retrieving and integrating data from a number of databases in a computer network in real-time, in situations where the volume of queries is high, system constraints will prevent the aggregation server from processing retrieved data from the agents all at once.

In U.S. Pat. No. 6,233,493 issued to i2 Technologies Inc. discloses a computer-implemented system for use in enterprise product development management and planning. The system is used to model the business enterprise in terms of its proposed products, tasks and resources required to develop a portfolio of products. The system has an optimising engine that uses a generic algorithm and constraints engine. The generic algorithm is used to provide sequences of products as candidates for the portfolio. The constraints engine develops schedules for each product sequence subject to constraints of the model. An iterative process is applied to evaluate each sequence in order to provide better sequences which will eventually result in a ‘best’ portfolio scenario. The optimising engine operates on an enterprise model which provides data for use in the development of an ‘optimal’ product portfolio.

WO 0102927A to Charles Wong discloses a business solution using a single application providing a virtual enterprise in which an entire business can be run via a web browser. The single self-sufficient application provides flexibility within the business through the utilisation of a web-enabled database providing the functional basis for business operations. The system uses an intelligent catalogue management system, real-time updating of transactions as well as providing a self-correcting knowledge-based design methodology to assist in overcoming user interface problems. Real-time financial information is also provided as ‘posting’ of financial information is undertaken automatically each time a user enters any form of financial transaction. The system therefore provides users with the ability to capture historical data, obtain current financial reports and undertake trend analysis on up-to-date information.

It is evident from the prior art discussed above that there is great potential for increasing business efficiency not only at the day-to-day operational level but also at the general business level through the provision of enhanced forward planning, budgeting and forecasting data necessary for running the business. Whilst the systems referred to operate in real-rime and are highly functional, none of the systems reside ‘in-house’ and provide dynamic updating of historic, current and forecast data as business transactions are undertaken thereby enabling a business to be continually aware of historic, current and future states.

### SUMMARY OF THE INVENTION

It is therefore an object of the present invention to provide an electronic business system for dynamically creating and displaying historic, current and forecast data in real-time on a moment to moment basis which at least goes some way towards overcoming the abovementioned disadvantages or which will at least provide the public with a useful choice.

Accordingly, in a first aspect the invention consists in a dynamic data engine used to forecast future demand of product units in real-time comprising:

means for storing unit sales data describing sales of said product units,

means for receiving unit sales data and continuously updating said stored unit sales data in real-time,

an algorithm for calculating forecast unit sales data of future unit sales based on the historical record of unit sales in said means for storing unit sales, wherein each product is uniquely represented by a multi-field product code each field being hierarchical, and

means for displaying sales forecasts in a plurality of views.

In a second aspect the invention consists in a demand driven supply chain management system including the dynamic data engine according to the first aspect to forecast a stock demand for a given customer, and further comprising:
means for modulating in real-time a flow of goods through said supply chain to meet a stock demand, and
means for determining a plurality of product stock levels across said supply chain.

In a third aspect the present invention consists in a method of forecasting product requirements using the dynamic data engine used according to the first aspect comprising the steps of:

preparing and inputting baseline forecast data for at least one customer,

generating forecasting data collection for each product to be allocated to said at least one customer,

receiving a history of sales data from said customer in real-time via an electronic interface once a sales transaction occurs,

generating a sales data collection from an allocation engine,

modifying customer budget data based on said sales transactions,

generating new forecasting data collection for said customer to replace said baseline forecast data, and

using said new forecast data collection as an operational forecast processing model.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

This invention consists in the foregoing and also envisages constructions of which the following gives examples.

### BRIEF DESCRIPTION OF THE DRAWINGS

Preferred forms of the present invention will now be described with reference to the accompanying drawings in which;

FIG. 1 is a high level process diagram illustrating the Forecast Quantity Allocation Pattern Model of the present invention,

FIG. 2 is a process diagram illustrating the Historic Group Model applied to the Forecast Quantity Allocation Pattern Model of FIG. 1,

FIG. 3 is a process diagram illustrating the Allocation Pattern Abstract Model applied to the Forecast Quantity Allocation Pattern Model of FIG. 1,

FIG. 4 is a process diagram illustrating the Lineage Model applied to the Forecast Quantity Allocation Pattern Model of FIG. 1,

FIG. 5 is a graphic output illustrating the top level forecasting view of the present invention,

FIG. 6 is a graphic output illustrating the general code and variant demand forecast view of the present invention,

FIG. 7 is a graphic output illustrating the historic group selection workspace of the present invention,

FIG. 8 is a graphic output illustrating the historic group selection view having a number of elements added to the historic group of the present invention,

FIG. 9 is a graphic output illustrating the option/size view for a particular product of the present invention,

FIG. 10 is a graphic output illustrating a purchasing view of the present invention,

FIG. 11 illustrates the process steps applied to the forecast main model of the present invention,

FIG. 12 is a graphic output illustrating the supply chain view for a particular product of the present invention,

FIG. 13 illustrates the process steps applied to the supply chain forecasting process model of the present invention,

FIG. 14 is a graphic output illustrating the demand forecasting model view for a particular product of the present invention, and

FIG. 15 is a table detailing key processes utilised by the dynamic business system of the present invention.

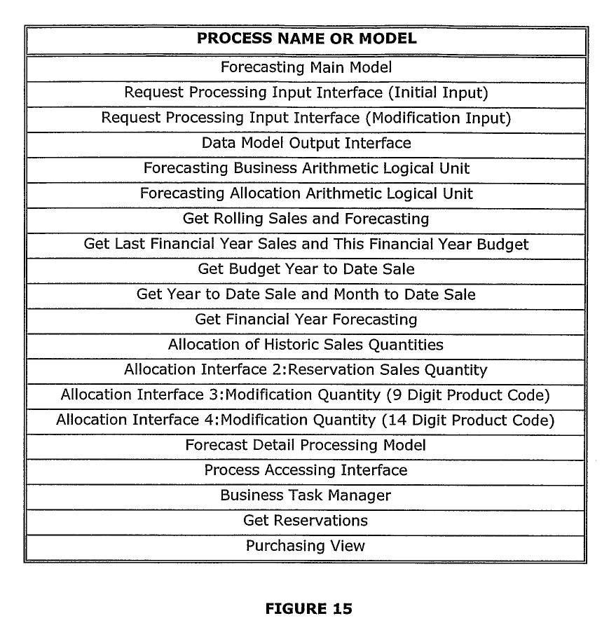

### DETAILED DESCRIPTION OF THE PREFERRED EMBODIMENTS

The business system of the present invention provides improvements over computer-implemented business systems currently available to a wide variety of enterprises. In particular a dynamic business enhancement system is described which dynamically updates historic transactions, current stock situation and demand forecast data as business transactions are undertaken which enables a business to be aware on a moment-to-moment basis of historic, current and future states.

The dynamic business enhancement system utilises a dynamic data engine for the purposes of creating and displaying historic transactions, current stock situation and forecasted demand data in real-time as the business performs transactions. As the data is created and cast forward, it retains attributes of the original transaction data. These attributes are configured and modified dynamically, resulting in precise and managed demand forecast, budget and purchasing information. Therefore every change in the raw data as a result of any business transaction is immediately reflected in the demand forecast; hence, the data is in a perpetual dynamic state.

It will be appreciated that the dynamic business enhancement system as described in the preferred embodiment of the present invention can be applied and used in any business area but will now be described below with reference to use in the wholesale distribution and retail industries.

### Embedded Intelligence

The use of an intelligent coding system is a fundamental aspect of the dynamic business enhancement system which is applied to demand forecasting, budgeting and purchasing processes. The main purpose of using an intelligent product coding system is to enhance the usability and value of stock codes in the searching, displaying and reporting on products. The product code comprises seven fields which can be grouped to form a continuous string or alternatively, split up into individual fields and each field may contain up to three alphanumeric characters. The intelligent code is capable of adding descriptors to existing product codes with embedded hierarchies along with other product details which are deciphered by referencing ‘dictionary’ tables in a database. The embedded hierarchies provide an ordered simple navigation throughout a product range as well as enabling fast searching to be undertaken.

An example of an intelligent coding system is shown in the tables below. The General Code is made up of five fields which contain specific information on a particular item. A further two fields may be appended to provide further product intelligence which may be used to describe the option, fit, colour and size of the particular product thereby giving the product variant detail.

General Code - 5 Field

| Brand | Category | Gender | Season | Model |
|---|---|---|---|---|
| AS | CR | W | W5 | 40 |

Variant - 7 Field (plus Barcode and Manufacturer Product Code)

| | Manufacturer's | | | | | | Option/ | |
|---|---|---|---|---|---|---|---|---|
| Barcode | Product code | Brand | Category | Gender | Season | Model | Colour | Size |
| 97623645 | 107 6548 | AS | CR | W | W5 | 40 | BL | 075 |

The code can be expanded to include a greater level of detail or alternatively reduced to provide less product detail depending on the users needs. This is done by varying the number of fields which are concatenated to form the alphanumeric intelligent code stream. The intelligent code may also be used to structure the departments, categories and sub-categories of a drill-down sequence in order to access products through a user interface such as a computer Graphical User Interface (GUI).

A new season code is generated by incrementing the ‘season’ field and saving the General Code and Variant details to the new season product code. This provides a historic reference for analysis and forecasting to be performed on the new product code item. As the new product code item has no historical lineage, a forecast pattern code is appended to the product code item which is in essence, forecast data from the previous season or seasons for the same or similar item. An item's lineage is generated by an “Allocation Engine” using the product forecast and actual data for the same or similar product items over the past one or more years. Similarly, each new customer is allocated a customer identifying code which is similar to an item's forecast pattern code enabling forecast, budget and sales data to be generated as a starting point for each new customer. The data will subsequently be varied and become individualised customer data as actual sales data is received from each customer. The information is dynamic and instantly updates with all activity which occurs within the system.

### Allocation Pattern Process

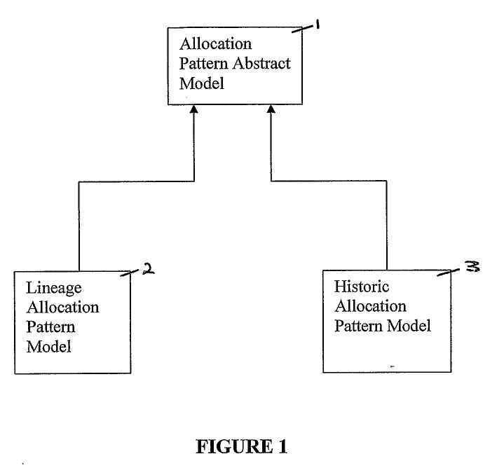

There are two ways of pattern modelling by using either lineage process data or by applying the historic group process data as illustrated in FIG. 1. Both the lineage and historic group data processes use the general product attributes including owner code, previous code, previous code type, pattern type, time filter and margin filter, stored in data storage 1. The user is then required to verify the options and size allocation percentages to ensure the match the particular owner code and once verified and set, the values are placed in data storage 2.

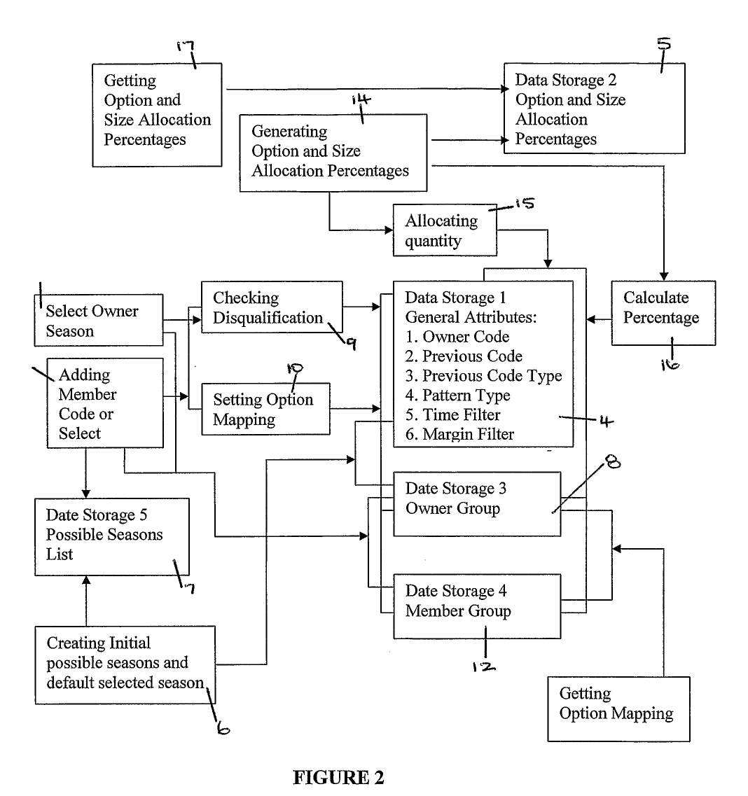

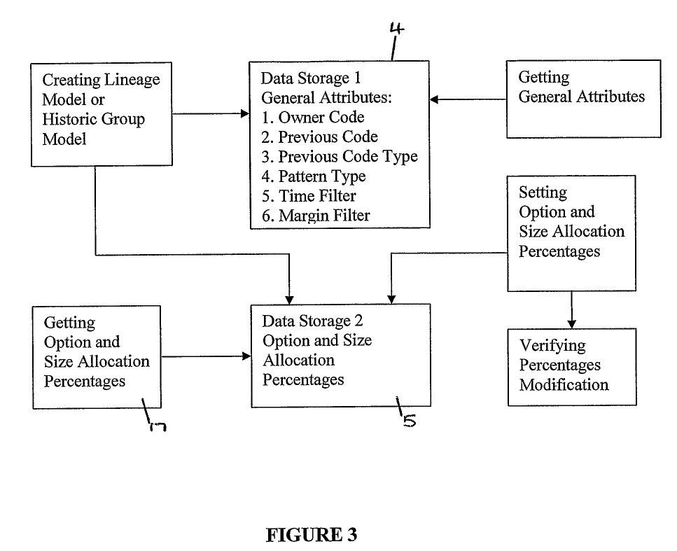

FIG. 2 shows the historic group data process which retrieves from the dynamic business system memory a previous historical group, if one exists. An initial possible seasons and default selected season range is created and allocated to an owner season and stored in a possible season list in data storage 5. Simultaneously, the selected season sizes are checked for disqualifications and an option mapping set and the configuration placed in data storage 3 owner group. Also, additional product member codes or select product member seasons are checked for disqualification and option mapping set before the configuration is placed in data storage 4 member group. If a new product member is added or additional member seasons are selected, the season list in data storage 5 is updated with the additional data. Option and size allocation percentages are generated and allocation quantity obtained to which option mapping is applied and the percentages calculated, the results of which are stored in data storage 2, Option and Size Allocation Percentages. The forecasting module then calls the allocation pattern model for the option and size allocation percentage as shown in FIG. 3.

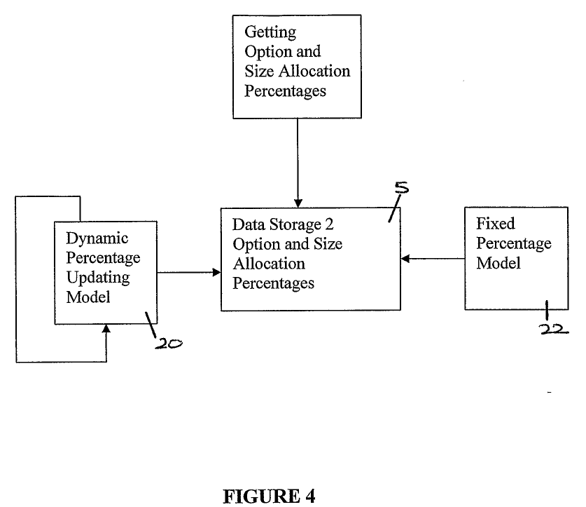

FIG. 4 shows the lineage model that can apply a dynamic percentage updating model as a default which is applied to option and size allocation percentages in data storage 2. An alternative option is to apply a fixed percentage (modified) model to the option and size allocation percentage data in data storage 2.

### Forecast Data

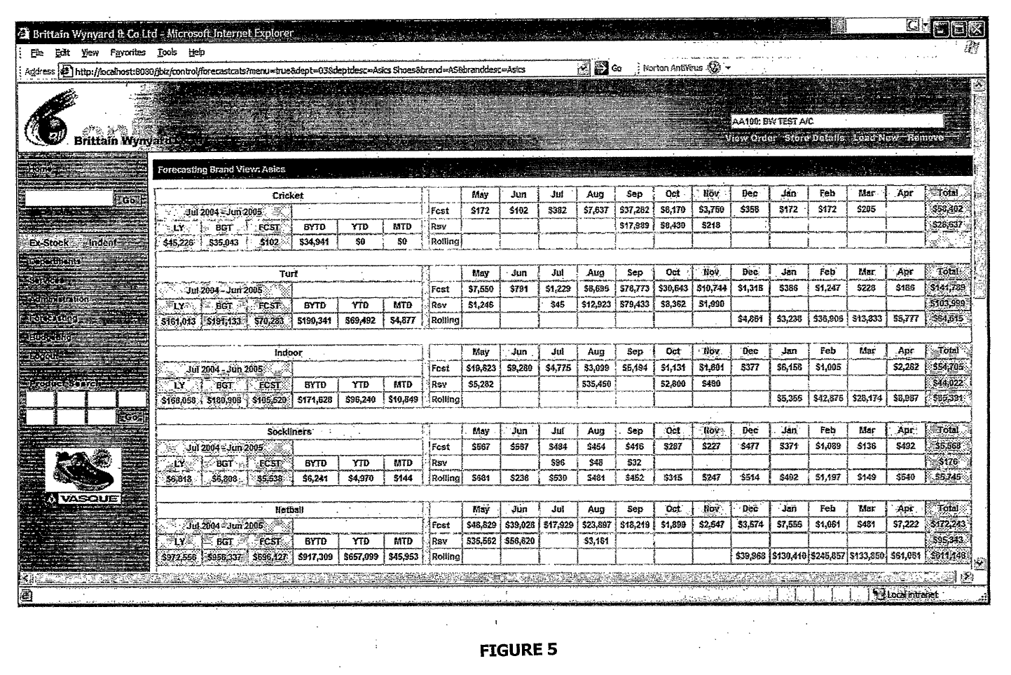

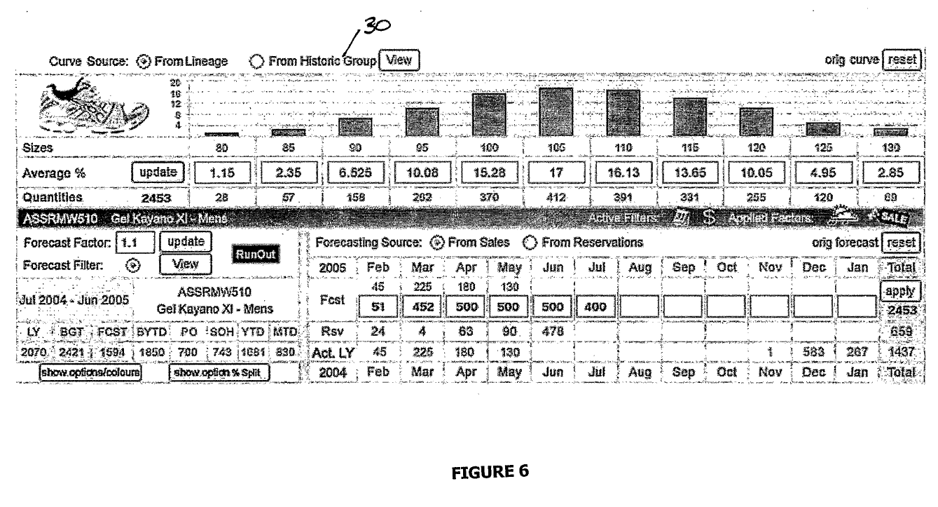

Forecast data is accessed by a ‘tumbling’ menu. The data presented enables a user to obtain forecast data for products by department, brand, category or sub-category as well as enabling a user to drill-up to the department level or drill-down to product variant level. FIG. 5 illustrates a typical graphical user output for data displayed at the product code level where the item has only one option and many sizes within that option. From this graphical output, the user can drill-down to more specific product data in relation to a particular brand or model number of the product. More detailed product information is shown in FIG. 6 and includes:
Product code, product image and description.
Variants (for example, size) within the general product code.
Variant percentage graph which is capable of being edited.
Variant quantities.
Graphical output selected from a curve source such as lineage or historic group.
Previous financial year sales (LY), budget and forecast.
Budget year to date (BYTD), actual sales year to date (YTD) and month to date sales (MTD).
Forecast for the current financial year including budget (BGT), sale (Fcst), YTD data plus the balance of budget amounts for the rest of the year (FCST). The forecast data is editable according to user requirements and can be compared with the original forecast data.
Product reservations out to 12 months forward.
Actual sales—current and back 12 months.
Forecast date which includes brand, category, sub-category, season, style, option, size, date and customer.
Forecast factor.
Forecasted quantity source—from sales or from reservations.
Purchase Orders (PO).
Stock on hand (SOH).
Reservations from the current month out to current month+11 (Rsv), and
Rolling sales back to current month−11 (Rolling).

The forecast data for future models or versions of products for the same period in the next year is generated by the dynamic data engine from transactions occurring within the business system as they happen. The continuous update of the raw data is therefore immediate and provides a continuous historic, current and future view of business performance as well as providing real-time stock movement updates from within the supply chain. Any changes to the general code forecast quantities are allocated to the variants by the “Allocation Engine” which dynamically allocates the changes across product variants. This allocation is based on dynamically generated model/colour/option/size/date/customer percentages from the current variable percentages. Alternatively, the allocation engine dynamically generates model/colour/option/size/date/customer percentages from either the previous code (or forecast pattern code), or alternatively by the percentages resulting from the Historic Group process. Hence, the forecast data is provided at variant level and can be displayed as either a company total, by customer or by customer group.

The forecast data can be edited by a user and will become the budget information at the end of the financial year as defined by the user. The forecast algorithms are configured using a forecast factor, the historic pattern and the average selling price to provide accurate data which flows through to both the budgeting and purchasing modules. Hence, the forecast data dynamically facilitates the purchasing process and also the sales budgeting process. Also, the forecasting data can be specified by a user in order to generate a “range” proposal or quote for a new season product or range of products for one or more customers.

### Redefining the Forecast

The default settings of the forecasting process deliver a forecasted result by applying a number of mathematical algorithms on the forecasting data. The user is given complete control enabling the user to modify all of the forecasting elements by activating and de-activating a number of filter elements such as:
Forecast factor which is a numeric multiplier.
Historic filters such as time-span and margin.
Weather factor which is a numeric value depending on long range weather forecast data.
Promotions factor which is a numeric value based on the influences of promotional activity undertaken.
Modifying the option and size percentage values.
Selecting a historic group of ‘like’ items to generate a colour/option/style/fit/size percentage curve.
Mapping unlike options between historic and new season items, and
Sales transaction data which is time-stamped enabling forecasted demand data to be viewed by month, week, day or hour and minute.

### Historic Groups

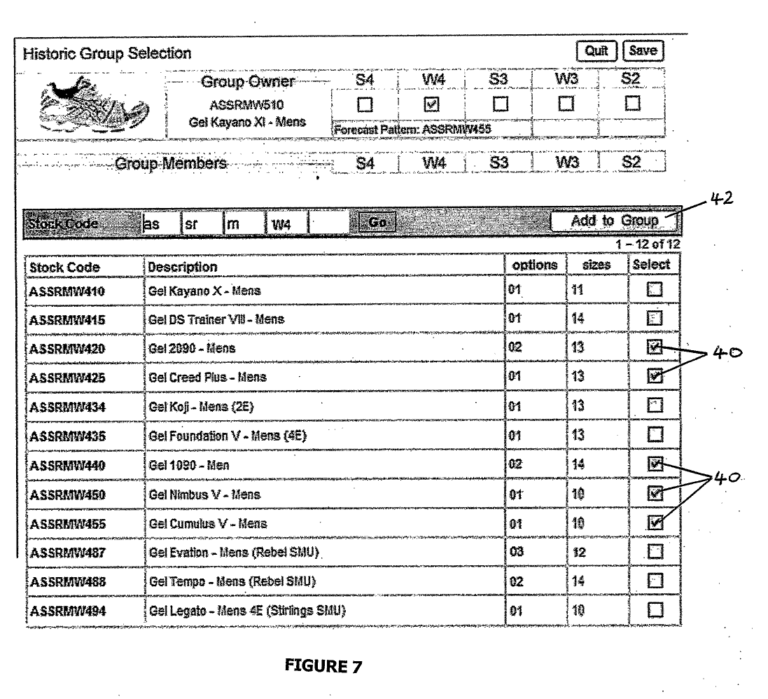

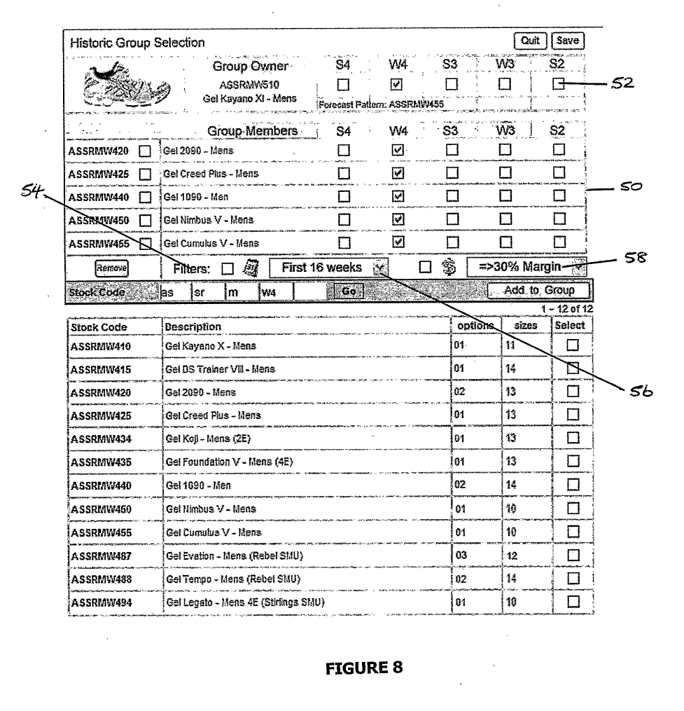

FIG. 7 illustrates step 1 of the workspace used to assemble an historic group for a particular product. When the user selects the historic group mode as illustrated in FIG. 6, the user is taken to the historic group workspace. The search result list is automatically populated with ‘like’ items based on the product's previous code or forecast pattern of the product being forecast (the Group Owner). The group owner details are displayed along with all possible seasons for the particular product type. From this view, the user selects items or candidates in order to add them to the group and thereby become a ‘member’ of the particular group. When the user selects the ‘Add to Group’ key, the candidates are analysed for type suitability and if they are validated the candidates are then added to the group as members as shown in FIG. 8. The user also has the ability to select the ‘season’ data for each of the group members to be included in the analysis calculation.

The historic group can have up to five members. Once the members are displayed, the user can apply filters to the member and group owner historic data. These filters are based on time-span and margin and are taken into consideration during the creation of the option percentages used in the forecasting of the group owner.

The time-span filter sets the length of time from the time of the first sale to be used in gathering data for the calculation. This enables the user to select data from a time period which is considered to contain quality sales being those sales which best reflect the true market.

The margin filter sets the minimum margin allowable for a transaction to be included in the data to be used in the forecast calculation. This enables the user to disregard any discounted sales as not being representative of the true market.

### Purchasing

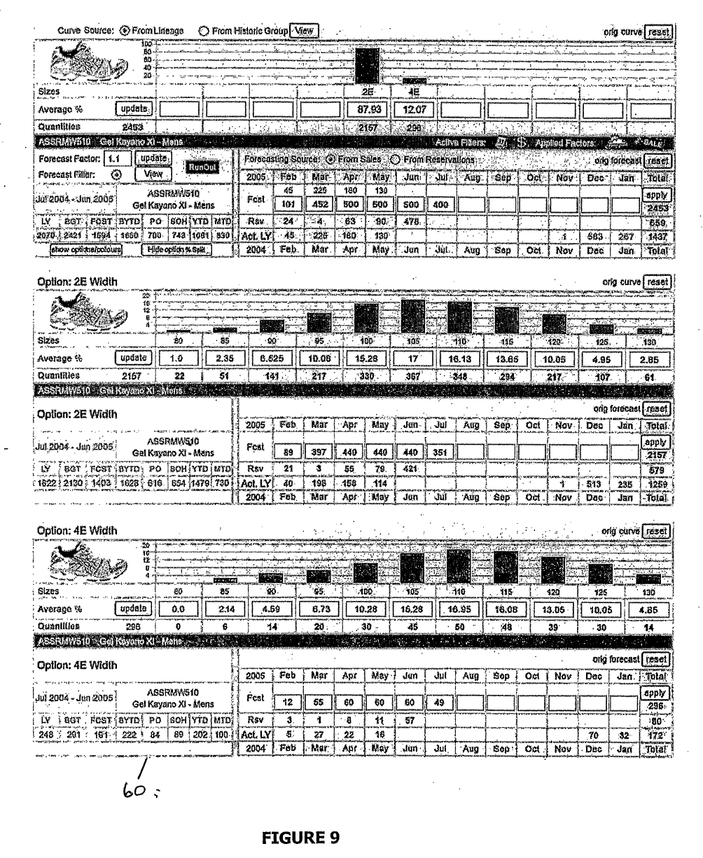

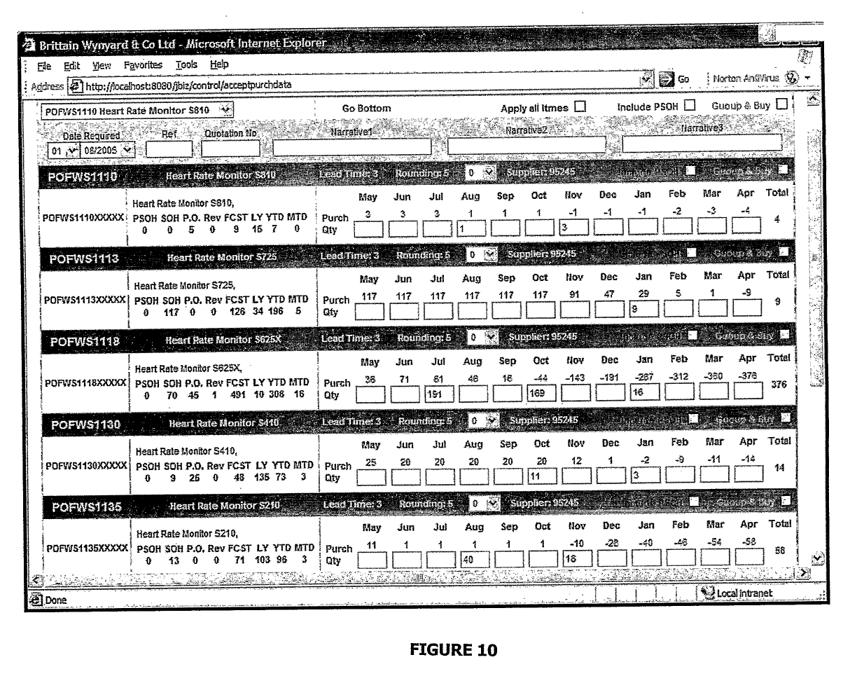

FIG. 9 illustrates a graphical output which is typically available to a user showing a combined general code and variant forecasting view. This graphic shows an edit to the general code forecast quantity and part of the distribution across the variants by percentage allocation as dictated by the dynamic allocation process. The original forecasted value is displayed immediately above the new quantity. It is from this view that the user can “Jump to Purchasing” which takes the current forecasted values in to the purchasing process. The purchasing graphical output as seen by a user is shown in FIG. 10. The information displayed to a user is as follows:
General code which includes the description, product lead time and rounding.
Group Quantities and Buy Now function.
Include previous code stock on hand (PSOH) in the calculation of purchase amounts.
Variant level and description.
Forward stock position.
Stock on hand (SOH).
Purchase orders already entered into the process (PO).
Reservations—reserved stock to meet existing orders for future delivery (Rev).
Forecast sales (FCST).
Last year sales (LY).
Year to date sales (YTD).
Month to date sales (MTD).
Purchase quantity.

This output is accessed by the user when the system undertakes a “Jump to Purchasing” process which applies purchasing functions and rules to the forecasted values. Various algorithms are applied for calculating a forecast for future sales based on historic sales and also for generating a continuous view of future stock levels and free to sell stock. The algorithms also include the quantity intelligent allocation of mapping from historic sales to the future season sales by matching the option, colour and size for the new season codes. It is also capable of handling mis-matching of new codes by evenly spreading the quantity to the options and colours of new codes and then finding the nearest size. Further, modifying the forecast quantity at the general code level will result in the quantity being spread down to the variant level for each variant based on the historic sales percentage of that particular variant.

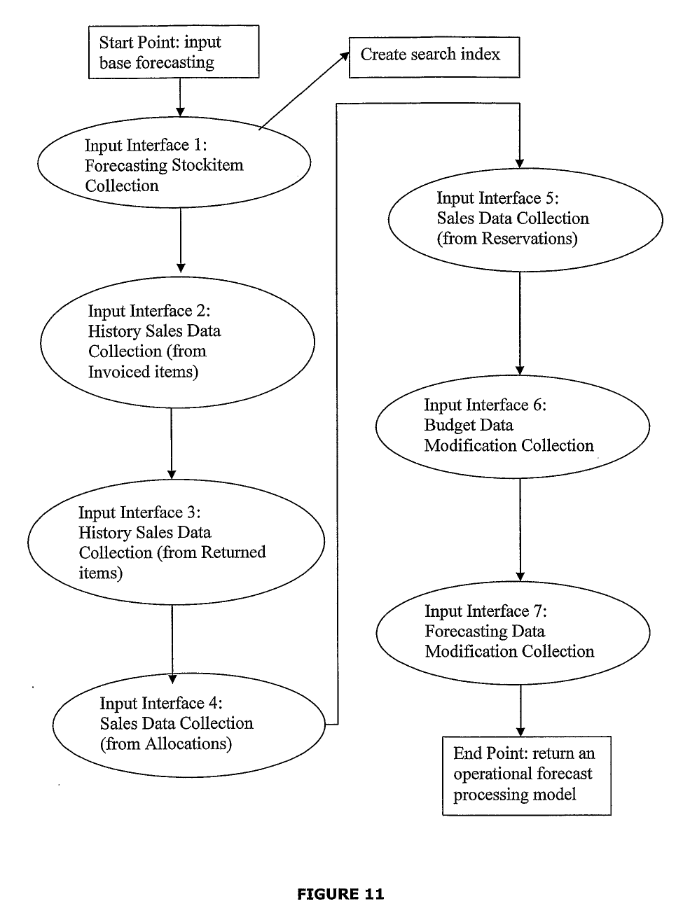

Demand forecasting is generated from historical sales records and these are adjusted by forecast factors and rounding to the minimum order quantities for purchasing. The forecast can be generated for the entire business or alternatively, for any of the business' customers. A number of processing steps are implemented during system operation the most relevant of which are listed at FIG. 11 with the forecasting process models described in more detail below.

### Demand Driven Supply Chain Management

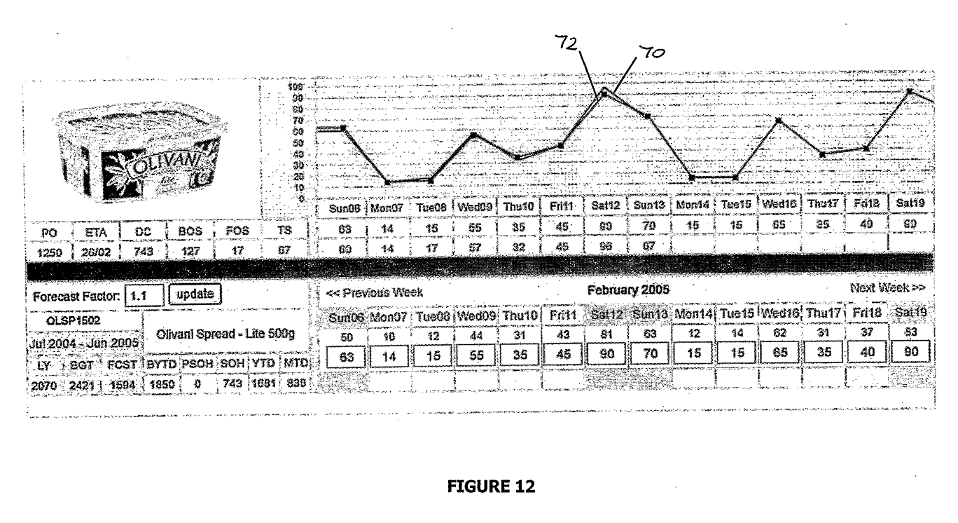

The dynamic business enhancement system enables demand driven supply chain management by providing visibility of the entire supply chain as shown in FIG. 12. The system forecasts demand based on the history for a given retail store within a chain of stores; however, transactions are time-stamped and therefore current trends can be identified by comparing forecasts with real-time point-of-sale transactions as illustrated in the graphical illustration in FIG. 12, where line 1 is the forecast sales and line 2 represents the actual sales. This enables the user to increase and decrease the anticipated forecast by changing line 1 on the graphical output by either clicking and dragging particular ‘day-points’ or by editing the daily forecasted quantities. This action modulates the flow of goods through the supply chain in order to meet demand. This will occur in real-time as actual sales data for each customer will come directly from the invoice processing system. The invoice processing system is synchronised with the dynamic business enhancement system database in real-time or alternatively, the invoice data can be read directly from the accounting system database. The dynamic business enhancement system is also capable of being interfaced with a point-of-sale transaction system. Hence, actual sales data is received by the dynamic business system as the transaction is being processed. Any form of interfacing can be used to connect the dynamic business enhancement system with transaction data, such as via the Internet, Local Area Networks (LAN), Wide Area Networks (WAN) and wireless technologies.

Where actual sales deviate (upwards or downwards) from the forecasted sales the supply chain flow will automatically modulate to meet the deviated sales requirements. Further, lead times and maximum/minimum stock levels are recommended in order to optimise the flow of stock through the supply chain while at the same time minimising the stock volume and the cost of stock within the supply chain. The dynamic business enhancement system recommends maximum/minimum stock levels for all the stock holding points in the supply chain based on forecasted demand and stock item lead times.

Store holding area has additional information available for review on a daily basis. This information includes:
Purchase orders (PO) which are items to be delivered to the distribution centre.
Delivery dates to the distribution centre (ETA).
“Available to ship” stock level in the distribution centre (net of unshipped requests) (DC).
Stock currently in the back of store warehouse area (BOS).
Stock currently on the shelf (FOS), and
Today's sales being stock sold today (TS).

In some stores not using for example, Radio Frequency Identification (RFID) technology to track stock within the store, it may not always be possible to identify Back of Store (BOS) and Front of Store (FOS) stock figures separately and stock will therefore be represented by an ‘in-store’ amount. The stock levels in a customer's store (FOS and BOS) are determined from the point-of-sale system and the BOS receipting system, which may be the same computer-based system. The benefit of separately identifying BOS and FOS stock levels within these areas is to ensure timely and accurate replenishment of the shelf space as the stock is moved from SOS to FOS and eventually sold. The dynamic business system according to the present invention is capable of recommending maximum and minimum stock levels for all the stock holding points in the supply chain based on the stock demand and lead-times for products. Hence, the demand forecast data flows to the purchasing module and is based on delivery lead-times to ensure adequate stock enters the supply chain in a timely manner whilst enabling the forecast demand to be met.

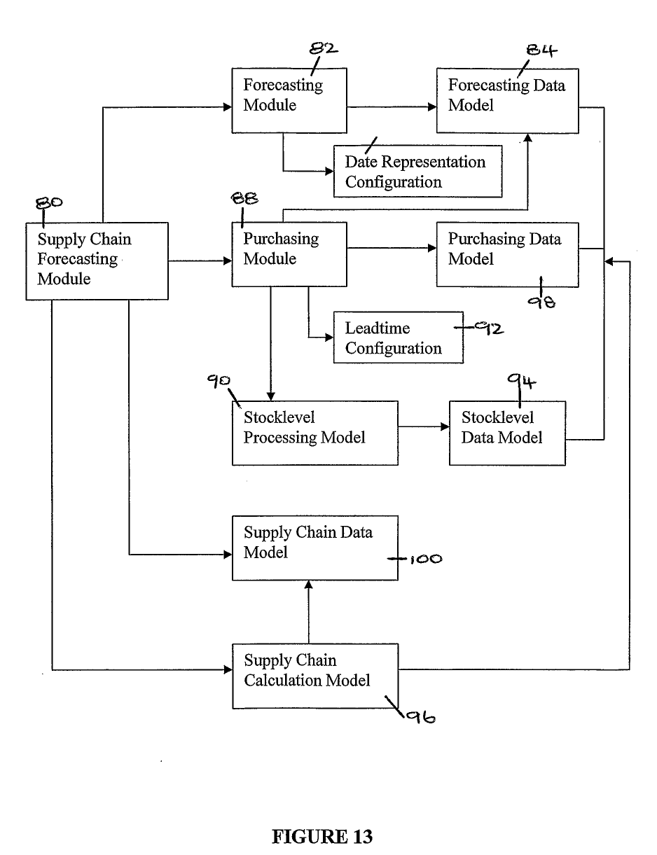

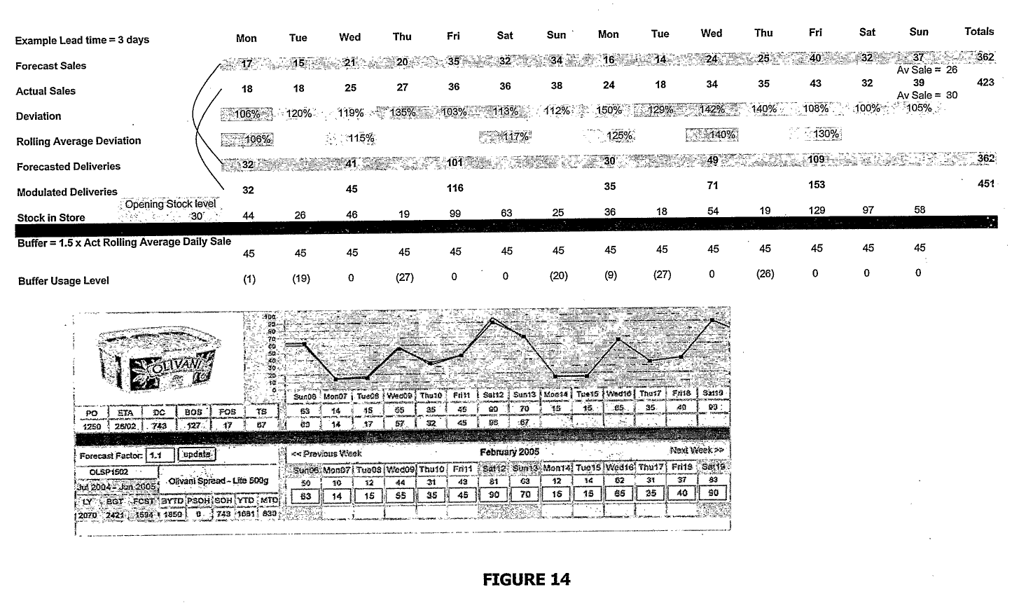

A number of elements are used in the demand forecast process including the following:
Lead Time—elapsed time from order placement to physical delivery.
Forecast—historic forecast, however the quantity is displayed by day as shown in FIG. 13 (demand forecasting model).
Actual Sales—actual sales read from point of sales transaction point whereby the deviation is the percentage difference between Forecast and Actual Sales data.
Rolling Average Deviation—average deviation for the present day [+(day-1)+(day-2) which is configurable].
Forecasted Deliveries—delivery quantity based on forecast demand.
Modulated Deliveries—calculated delivery quantity (forecast delivery quantity multiplied by the rolling average deviation as at the lead time [3 days, for example] as shown in FIG. 14).
Stock in Store—stock in BOS and FOS.
Buffer—dynamically generated buffer of stock quantity which is generally set to one and a half times the average daily sales quantity as shown in FIG. 14. This is designated to cover positive sales deviations to help ensure a 100% in stock situation. This buffer is used to generate an additional quantity to be added to the modulated delivery quantity. It is also a guide to assess “what if” sales volumes and thereby gauge the need to manually intervene in future forecast in order to modify the delivery quantities prior to their being modulated by the Rolling Average Deviation.
Buffer Usage Level—the amount of the buffer quantity being used to satisfy demand. This amount of usage is then added to the modulated delivery quantity resulting in a robust “in stock” predictor mechanism. The user is capable of manually intervening in the supply chain process by editing the forecast by dragging line 1 and/or changing the forecast factor.
Forecast Factor—factor by which last years' sales are multiplied. The dynamic business enhancement system recommends a change to the forecast factor based on the Rolling Average Deviation.

The supply chain forecasting model is identical for both a retail store and a distribution warehouse. The only difference between the retail store and distribution warehouse situation being that in the retail store actual sales are point-of-sale transactions and modulated deliveries are shipments from the distribution warehouse; however, at the distribution warehouse, actual sales are replenishment orders from the retail stores and modulated deliveries are orders to third party supplies or manufacturers.

The demand forecasting process elements are incorporated in the supply chain forecasting processing model as illustrated in FIGS. 13 and 14. The supply chain forecasting model requires the interaction of a number of processing and calculation modules to generate the supply chain forecast data. The processing involves the following steps. The Supply Chain Processing Module calls the Forecasting Module to set the Forecasting Data Model which is to be used as the basis of the data to be used in order to generate the future calculations. The Forecasting Module needs to be set to Supply Chain Mode in order to generate the basic data information for this model whereby the working mode of the Forecasting Module is set by the Date Representation Configuration. The Supply Chain Processing Module then calls the Purchasing Module and the Stocklevel Processing Model to set the demand figure for use by the Purchase Data Model whereby the process is carried out by the configuration of Leadtime. The Purchasing Module takes the calculation based on the result from Forecasting Data Model and the Stocklevel Processing Model to get the stock-level information from the Stocklevel Model. The Supply Chain Processing Module then calls the Supply Chain Calculation Model to perform the calculation by the defined Math Model algorithm within it This calculation is as follows:

Deviation=the percentage difference between forecast and actual sales

Rolling average deviation=average deviation for the current day+(average deviation for current day −1)+(average deviation for current day −2)

The rolling average deviation is configurable to the number of days which equate to the lead time for deliveries. As illustrated in the demand forecasting model at FIG. 13, the lead time is three days but is dependant on each of the product manufacturers.

The Supply Chain Calculation Model then calls for each of the results from the Forecasting Data Model, Purchasing Data Model and Stocklevel Model as the basic data applied to the defined Math Model in order to make further calculations and store the results into the Supply Chain Data Model. The typical calculations include:

Modulated delivery quantity=(forecasted delivery quantity×rolling average deviation+buffer usage quantity)

The Supply Chain Processing Module then calls for the final results being the new delivery order based on demand, which are stored in the Supply Chain Data Model thereby generating forecast data for the supply chain.

The demand driven forecasting function is based on the principle of having the “best possible” forecast baseline which is generated by the dynamic business system of the present invention. The system is capable of recognising daily trends as a deviation from the forecast and then average the deviation by the delivery lead time before finally modulating the forecasted delivery by the average deviation percentage. In this way the supply is modulated based on trends while at the same time retaining the “shape” of the forecast. The process is circular such that two to three days deviation is applied to the next two to three days. Further, stock volumes in the supply chain can be minimised which will reduce the cost of goods in the supply chain.

### Forecasting Process Model

With reference to FIG. 11, the user can interface the dynamic business system according to the present invention via a program Request Process Input Interface which is called by gathering the base forecast data the first time the module is used in a session resulting from a request being made to generate a forecast view. Data Model Output Interface is a program having a user interface which is also called by accessing the top level of the forecasting data model, called the Division Data Model, by way of the hierarchy generated by the unique intelligent structure of the system's product code.

The forecasting processing model then calls on two subroutines, the request ditribution routine and a data model generation routine. The request distribution routine finds out which products need to be taken to the ‘allocation objects’ which are dated from the corresponding month of history sales. The data model generation routine generates the forecasting data model by calling the lower general code processing model to get the “General Code Data Model” which is the foundation of the forecast data model. This process results in the remainder of the forecast data models being generated by the lower detail processing model as well as upwards to the top Division Data Model. The user interface program is then capable of accessing each layer of the hierarchy from the top [Brand] to the bottom [Variant].

The Forecasting General Code Processing Model routine provides the fundamental process of the business logic and data model generation. The business logical processing routine consists of an intelligent allocation unit, a high level business data processing unit and a data processing control unit. These units cooperate with each other to respond to each request from the upper processing level. The data model generating unit generates the lower level forecasting data model.

The forecasting detail processing model is an advanced data structure and the base processing is done at the bottom processing level of the stored forecasting data. The model is comprised of the base data allocating routine which allocates the data to each individual data structure for the different data sources selected by the upper processing layer, plus a base data model generation routine. This routine generates the bottom level of forecasting data model called “Detail Data Model”. The logical process is the extraction of data from the top processing level downwards (from Division Data Model down to Detail Data Model) such that data models are encapsulated to get the data model for the view of each layer. However it is also possible to process upwards which generates the data model based on the lower layer data up to the top layer (from Detail Data Model up to Division Data Model).

The main forecasting processing model may be further described with reference to FIG. 11 which shows the steps undertaken in updating the base forecast to achieve an operational forecast. Input Interface 1 (forecasting stock item collection) gathers and collates the stock items to be forecasted from within the data range defined by a user request which selects certain tables of ‘stockitem’ and ‘stockitemext’ in the database which is defined by division and/or department and/or brand and/or category. This routine then creates the lower level processing models (forecasting general code processing model and forecasting detail processing model) in which the previous code or forecast pattern, forecast factor, rounding and wholesale price have been set. A search index is created concurrently and is used to help locate any required stock items which may be currently in memory as a result of run time processes.

The second interface (history sales data collection) collects the historic sales records from two invoicing database tables. The period of the data range is from the beginning of the last financial month/year to the same month for the current financial year. The sales achieved from the last financial year are used to calculate the budget for the current financial year. The year-to-date sales and month-to-date sales are also calculated from within the same data range. Sales in the current month are also used to make up the core data for forecasting the equivalent sales for the next financial year. The sales quantities are allocated through a distribution unit which locates the relevant stock item and analyses the historic pattern for option, colour, size, style, date and customer. The retrieved sales quantities and actual selling price are attributed to the relevant code being forecasted. Where the data range includes more than one season (for example Winter 02, Winter 03 plus Winter 04) and as the data range can be extended up to 23 months, then the Distribution Unit analyses data from both the Previous Code and the Previous/Previous Code in order to calculate the next financial year forecast. Hence, the dynamic nature of the transaction data enables data to be immediately available for sales reporting purposes.

The data collection interface for returned items (Interface 3) collaborates with interface 2 in order to deduct returned items from the month the returned item was invoiced. Interfaces 4 and 5 provide data on future confirmed sales (backorders) and reserved sales from at least two database tables containing order information. The budget for the current financial year is then set via interface 6. This interface obtains and collates sales data modifications in each of the historic forecasted months and locks them at the end of the financial year. The historic sales records are simultaneously adjusted by the modifications and become the budget for the current financial year. Similarly the adjusted historic sales records provide the data used for the future months forecasting.

All these steps are undertaken in order to complete the initialization of the forecasting process for a particular user request after which the system returns to the Forecast Processing Model ready to be used for any further processing.

1. A dynamic data engine used to forecast future demand of product units in real-time comprising:
means for storing unit sales data describing sales of said product units over multiple seasons,
means for receiving unit sales data and continuously updating said stored unit sales data in real-time,
means for appending a forecast pattern code to a new product units product code which is substantially equivalent to a previous season's product code where said new product unit is substantially equivalent to the product unit represented by said previous season's product code,
an algorithm for calculating forecast unit sales data for future unit sales based on the historical record of unit sales in said means for storing unit sales, wherein each product for each season is uniquely represented by a multi-field product code which provides an historical reference when undertaking analysis or forecasting for future unit sales, at least one field of said multi-field product code being hierarchical, and
means for displaying sales forecasts in a plurality of views.

2. A dynamic data engine according to claim 1 wherein each view is produced in response to input query data in one or more fields of said multi-field product code.

3. A dynamic data engine according to claim 1 wherein said multi-field product code comprises a plurality of fields grouped to form a continuous alphanumeric string.

4. A dynamic data engine according to claim 3 wherein said fields contain information on a product including department, category, sub-category, gender, season and model which make up a “General Code” product sub-set.

5. A dynamic data engine according to claim 4 wherein said fields contain additional information on said product including a colour/option, a size and at least a manufacturer product code which make up a “Variant” product sub-set.

6. A dynamic data engine according to claim 5 wherein said forecast pattern code comprises said forecast unit sales data for at least one previous season's product code.

7. A dynamic data engine according to claim 4 wherein a new season product code is created using an existing product code but incrementing said season field.

8. A dynamic data engine according to claim 1 wherein a product lineage is generated for a new product unit using a record of actual unit sales data for at least one previous product code representing a product unit which is substantially equivalent to said new product unit.

9. A dynamic data engine according to claim 8 wherein said lineage is generated by an allocation engine for a new product code for said new product item.

10. A dynamic data engine according to claim 9 wherein said allocation engine uses said lineage and a record of current forecast data for said product code to generate a lineage for said new product code.

11. A dynamic data engine according to claim 10 wherein said allocation engine generates a product lineage for at least one product code for a customer.

12. A dynamic data engine according to claim 10 wherein said product lineage is updated automatically and in real-time on receiving actual sales data.

13. A dynamic data engine according to claim 11 wherein said customer is allocated a customer identifying code.

14. A dynamic data engine according to claim 13 wherein said customer identifying code is substantially similar to said forecast pattern code enabling said dynamic data engine to generate a baseline forecast and a budget data for sales for said customer.

15. A dynamic data engine according to claim 1 wherein said means for receiving unit sales data is achieved via an electronic interface to at least one customer database system.

16. A dynamic data engine according to claim 15 wherein said electronic interface acts via the Internet.

17. A dynamic data engine according to claim 15 wherein said electronic interface is acts a Wide Area Network connection.

18. A dynamic data engine according to claim 15 wherein said electronic interface is acts a Local Area Network connection.

19. A dynamic data engine according to claim 15 wherein said electronic interface is acts a Wireless Network connection.

20. A dynamic data engine according to claim 1 wherein said algorithm for calculating forecast unit sales data future unit sales is configured to apply a forecast factor, a historic forecast pattern and an averaged unit selling price.

21. A dynamic data engine according to claim 20 wherein said algorithms is configured to provide data for use in a budgeting and a purchasing process model.

22. A dynamic data engine according to claim 1 wherein said forecast unit sales data for a future version or model of a product for a same time next year is generated from a plurality of transactions in said dynamic data engine as said plurality of transactions occur thereby providing an immediate and an historic, a current and a future view of a business performance and movements of stock items.

23. A dynamic data engine according to claim 22 wherein said forecast data is at a variant level and displayed on said display means at a company, department or customer level.

24. A dynamic data engine according to claim 22 wherein said forecast unit sales data is editable by a user such that said forecast unit sales data becomes a budget of future unit sales at a predetermined date.

25. A dynamic data engine according to claim 24 wherein said editable forecast unit sales data at a general code level is processed by a dynamically generated allocation engine used to allocate a plurality of edited quantities across a plurality of products based on a dynamically generated percentage split calculated from a current variable percentage.

26. A dynamic data engine according to claim 22 wherein using said forecast data from a previous season product or a plurality of previous season's product historic group data has a plurality of calculations performed on said forecast data to create a percentage split which can be used to configure said allocation engine for a forecasting event.

27. A dynamic data engine according to claim 22 wherein said forecast data is capable of being used to facilitate a purchasing process.

28. A dynamic data engine according claim 22 wherein said forecast data is capable of being adjusted by a forecast factor and used to provide a minimum order quantity.

29. A dynamic data engine according to claim 22 wherein said forecast data is capable of being specific to a sales entity.

30. A dynamic data engine according to claim 22 wherein said forecast data is capable of being specific to a sales entity's customers.

31. A dynamic data engine according to claim 22 wherein said forecast data is capable of being specified for use as a proposal for said sale's entity's customer.

32. A dynamic data engine according to claim 26 wherein said historic group data is capable of being filtered to select a user specified range for said percentage split calculation.

33. A demand driven supply chain management system including the dynamic data engine of claim 1 to forecast stock demand for a given customer, and further comprising:
a means for modulating in real-time a flow of goods through said supply chain to meet a stock demand, and
a means for determining a plurality of product stock levels across said supply chain.

34. A demand driven supply chain management system according to claim 33 wherein said means for modulating in real-time a flow of goods comprises means for re-calculating a forecast of sales of said goods based on an actual sales value deviation.

35. A demand driven supply chain management system according to claim 33 wherein said modulated flow of goods provides a means of optimising said stock levels across said supply chain.

36. A demand driven supply chain management system according to claim 33 wherein said forecast stock demand is based on a demand history for said customer.

37. A demand driven supply chain management system according to claim 33 wherein said forecast stock demand can be modified by a user as a result of said user receiving a plurality of real-time point-of-sale transaction data.

38. A demand driven supply chain management system according to claim 33 wherein said means for determining a plurality of product stock levels across said supply chain monitors a customer's stock levels in a store.

39. A demand driven supply chain management system according to claim 38 wherein monitoring of said customer's stock levels is achieved by receiving in real-time said stock levels from a customer stock receipting system and a customer point-of-sale transaction system.

40. A demand driven supply chain management system according to claim 38 wherein said dynamic data engine is capable of recommending a maximum and a minimum stock level for said customer within said supply chain by monitoring in real-time said customer stock levels thereby enabling said forecast demand to be met.

41. A method of forecasting product requirements using the dynamic data engine of claim 1 comprising the steps of:
preparing and inputting baseline forecast data for at least one customer,
generating forecasting data collection for each product to be allocated to said at least one customer,
receiving a history of sales data from said customer in real-time via an electronic interface once a sales transaction occurs,
generating a sales data collection from an allocation engine,
modifying customer budget data based on said sales transactions,
generating new forecasting data collection for said customer to replace said baseline forecast data, and
using said new forecast data collection as an operational forecast processing model.

42. A method of forecasting product requirements according to claim 41 wherein said step of generating said forecasting data collection includes gathering and collating a plurality of stock items within a user specified data range within a product database.

43. A method of forecasting product requirements according to claim 42 wherein said step of generating said forecasting data collection is used to create a forecasting general code processing model and a forecasting detail processing model which has a previous forecast pattern, a forecast factor and a pricing scheme set.

44. A method of forecasting product requirements according to claim 41 wherein said step of receiving a history of sales data in real-time is achieved by receiving said sales transactions from an online point-of-sales transaction system.

45. A method of forecasting product requirements according to claim 41 wherein said step of receiving a history of sales data is obtained from a database containing a plurality of sales data from at least one previous financial year and wherein said sales data is used to calculate a budget for a current financial year.

46. A method of forecasting product requirements according to claim 41 wherein said step of generating said sales data collection is obtained from at least one database which stores a plurality of future confirmed sales data and a plurality of reserved sales data.

47. A method of forecasting product requirements according to claim 41 wherein said step of modifying said customer budget data calculated when said real-time sales transaction data is collated with said historic sales data in order to adjust said customer budget data for a current financial year.

48. A method of forecasting product requirements according to claim 47 wherein said step of modifying said customer budget data enables said historic sales data which is adjusted by said real-time sales transaction data to provide a plurality of forecasting data for a plurality of future months.

49-51. (canceled)
